(19) United States
(12) Patent Application Publication
(10) Pub. No.: US 2018/0059723 A1
(43) Pub. Date: Mar. 1, 2018

(54) ELECTRONIC DEVICE

(71) Applicant: PEGATRON CORPORATION, TAIPEI CITY (TW)

(72) Inventors: Hung-Yun Wu, Taipei City (TW); Shyh-Heh Hwang, Taipei City (TW); Ho-Ching Huang, Taipei City (TW); Hui-Chen Wang, Taipei City (TW); I-Tien Hsieh, Taipei City (TW)

(73) Assignee: PEGATRON CORPORATION, TAIPEI CITY (TW)

(21) Appl. No.: 15/597,988

(22) Filed: May 17, 2017

(30) Foreign Application Priority Data
Aug. 26, 2016 (TW) 105127373

(51) Int. Cl. G06F 1/16

(52) U.S. Cl. CPC G06F 1/1632

(57) ABSTRACT

An electronic device includes a display and a base. The display includes a first connector and a display surface and a back surface opposite to each other. The first connector is located on the back surface of the display. The base includes a second connector. When the display is assembled to the base, the second connector of the base is connected to the first connector of the display along a connecting direction. The connecting direction is perpendicular to the display surface of the display.

### CROSS-REFERENCE TO RELATED APPLICATION

This application claims the priority benefit of Taiwan application serial no. 105127373, filed on Aug. 26, 2016. The entirety of the above-mentioned patent application is hereby incorporated by reference herein and made a part of this specification.

### BACKGROUND

### Technology Field

The invention is related to an electronic device, and particularly to a portable electronic device.

### Description of Related Art

With rapid advancement of technologies, various portable electronic devices such as notebook computers, smart phones, tablet PCs and the like have been developed. Users can edit, send and receive data via the portable electronic device at any time everywhere. Therefore, portable electronic devices have become important products in people's daily lives. Nowadays, there is also a type of electronic device which has a body equipped with a screen (i.e. a tablet PC) and a body equipped with a keyboard (i.e. a docking station) that can be separated from each other or assembled to each other depending on the user's need. Such electronic device can be used selectively as a tablet PC or a notebook computer.

For this type of electronic device, the signal transmission between the tablet PC and docking station is carried out in the manner that the tablet PC is vertically inserted on the docking station in general. When the connection between tablet PC and docking station are slightly shifted, the pins between the connector cannot be aligned accurately, leading to disconnection or distortion of signal transmission. In the meantime, the connector of the tablet PC is generally disposed on one side of the tablet PC, and the size of the connector is restricted to the thickness of the body of tablet PC. Under the circumstances where a rugged tablet PC or an industrial tablet PC is used, the connector used for such type of tablet PC is also larger because more pins are required and the pitch between the pins is bigger as well. However, under the circumstances where the thickness of the tablet PC cannot be changed, it is not possible for the larger connector to be installed in the limited space on the side of the tablet PC.

### SUMMARY

The invention provides an electronic device which has a better assembling accuracy.

In the invention, the electronic device comprises a display and a base. The display comprises a first connector and a display surface and a back surface opposite to each other. The first connector is located on the back surface. The base comprises a second connector. When the display is assembled to the base, the second connector of the base is connected to the first connector of the display along a connecting direction. The connecting direction is perpendicular to the display surface of the display.

In one embodiment of the invention, the base comprises a body, a docket station and a back cover. The docket station is disposed on the body. The back cover is pivoted to the docket station to be opened or closed relative to the docket station, wherein the back cover comprises a second connector.

In one embodiment of the invention, the back cover comprises a cover portion and a connecting portion. The connecting portion is connected between the cover portion and the docket station, and the second connector is disposed on the connecting portion.

In one embodiment of the invention, when the back cover is opened relative to the docket station at an angle, the display is assembled to the docket station of the base along an assembling direction.

In one embodiment of the invention, the angle is in a range of 0 degree to 45 degrees.

In one embodiment of the invention, the assembling direction is parallel with a display surface of the display.

In one embodiment of the invention, when the back cover is closed relative to the docket station, the second connector of the back cover is connected with the first connector of the display, and the back cover covers the back surface of the display.

In one embodiment of the invention, the display is a tablet PC.

Based on the above, in the display of the electronic device in the invention, the first connector is disposed on the back surface opposite to the display surface. As compared with conventional tablet PC of which the connector is disposed on the side of the tablet PC, the size of the first connector in the invention is not restricted to the thickness of the display. In addition, the display of the electronic device in the invention is assembled to the base first. Subsequently, the second connector of the base is connected to the first connector of the display along a connecting direction perpendicular to the display surface of the display. As compared with conventional tablet PC which is vertically inserted on the docking station, the electronic device in the invention can have better assembling accuracy.

In order to make the aforementioned features and advantages of the invention more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a base of an electronic device according to one embodiment of the invention.

FIG. 2 is a side view of a back cover of a base in FIG. 1 being opened relative to a docket station at an angle.

FIGS. 3 and 4 are schematic views illustrating a display assembled to the base in FIG. 1.

FIG. 5 is a side perspective view of an electronic device in FIG. 1.

### DESCRIPTION OF EMBODIMENTS

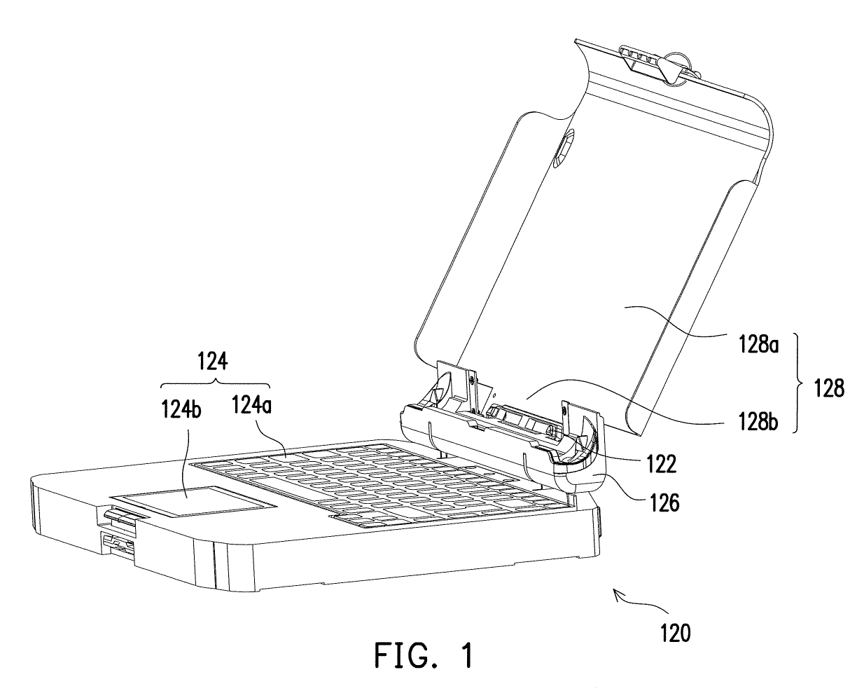

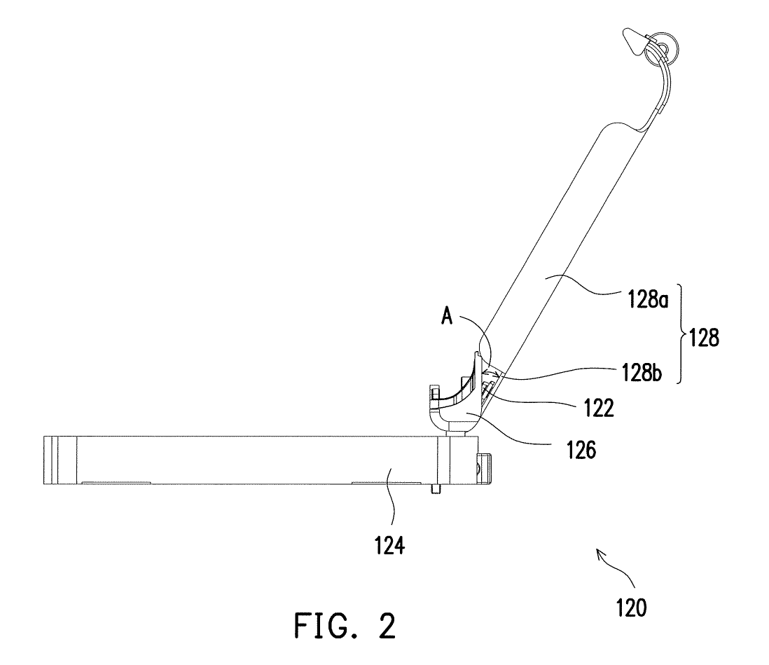

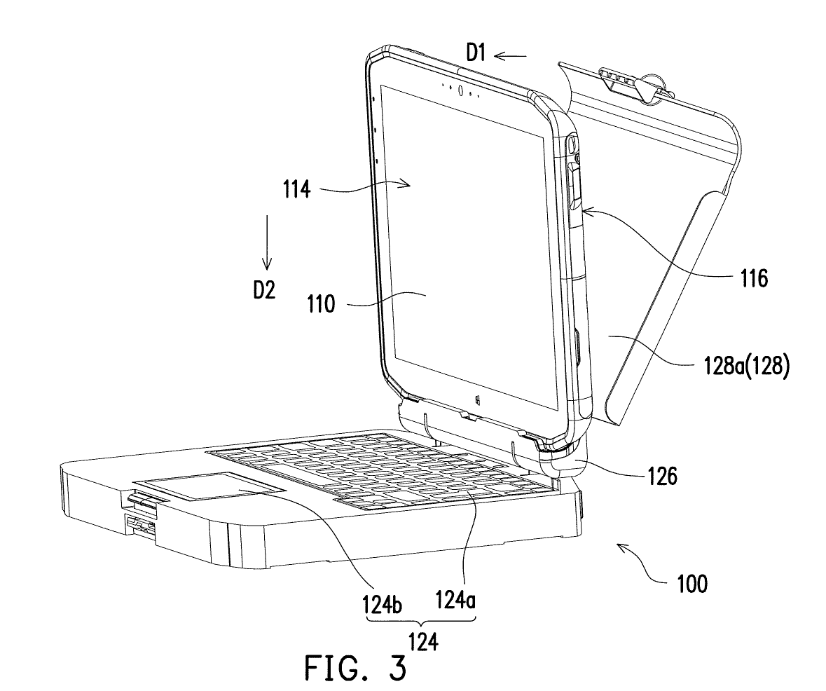

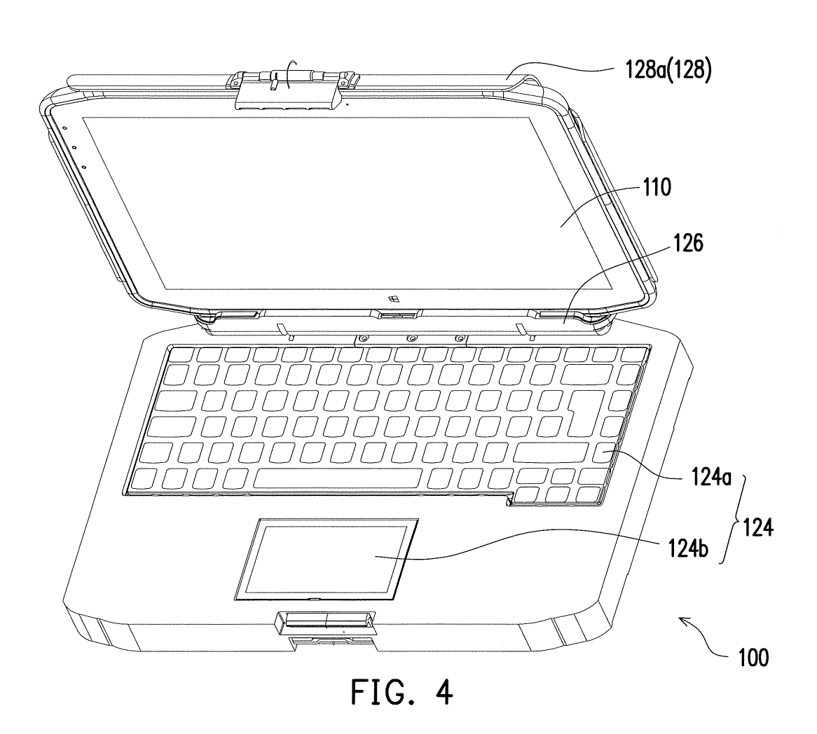

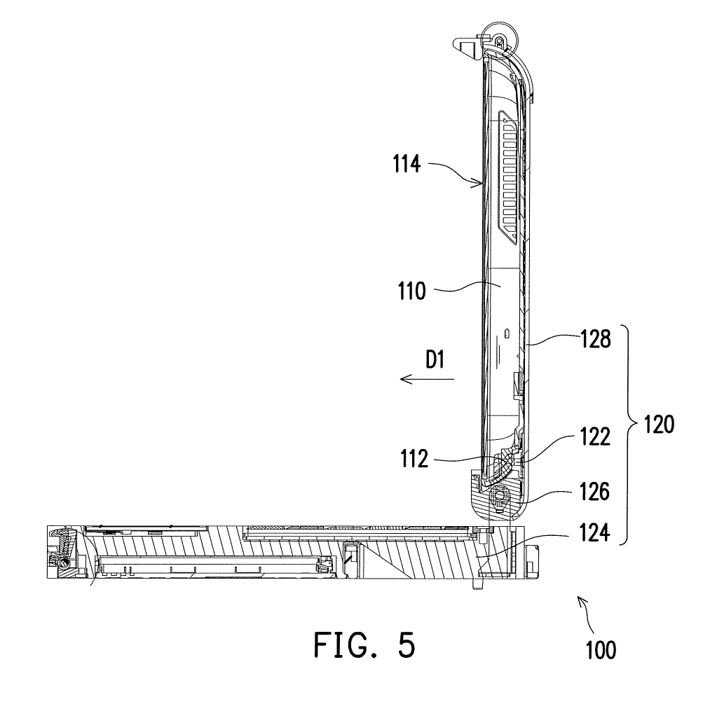

FIG. 1 is a schematic view of a base of an electronic device according to one embodiment of the invention. FIG. 2 is a side view of a back cover of a base in FIG. 1 being opened relative to a docket station at an angle. FIGS. 3 and 4 are schematic views illustrating a display assembled to the base in FIG. 1. FIG. 5 is a side perspective view of an electronic device in FIG. 1. Referring to FIGS. 1, 3 and 5 at the same time, in the embodiment, an electronic device 100 comprises a display 110 and a base 120. The display 110 comprises a first connector 112 as well as a display surface 114 and a back surface 116 opposite to each other. The first connector 112 is located on the back surface 116. The base 120 comprises a second connector 122. When the display 110 is assembled to the base 120, the second connector 122 of the base 120 is connected to the first connector 112 of the display 110 along a connecting direction D1. The connecting direction D 1 is perpendicular to the display surface 114 of the display 110.

Specifically, referring to FIGS. 3 and 5, take a notebook computer as an example; the display 110 is a tablet PC, for example, wherein the first connector 122 is disposed on the back surface 116 of the display 110. As compared with conventional tablet PC of which the connector is disposed on the side of the tablet PC, the size of the first connector 122 in the embodiment is not restricted to the thickness of the display 110.

Moreover, referring to FIGS. 1 and 2, the base 120 in the embodiment comprises a body 124, a docket station 126 and a back cover 128. The body 124 is, for example, a host part of the notebook computer and equipped with an operating element (e.g. a keyboard 124a or a touch plate 124b, etc.). The docket station 126 is disposed on the body 124 to be assembled to the display 110. Here, the docket station 126 may be fixed on the body 124 or may be rotated relative to the body 124; the invention provides no limitation thereto. The back cover 128 is pivoted to the docket station 126 to be opened or closed relative to the docket station 126. The back cover 128 comprises a second connector 122.

Furthermore, the back cover 128 in the embodiment can be opened or closed relative to the docket station 126 via an elastic hinge (not shown). The back cover 128 comprises a cover portion 128a and a connecting portion 128b. The connecting portion 128b is connected between the cover portion 128a and the docket station 126, and the second connector 122 is disposed on the connecting portion 128b. As shown in FIGS. 4 and 5, the cover portion 128a of the back cover 128 can cover the surface around the display 110 to protect and enhance structural strength of the display 110. The second connector 122 disposed on the connecting portion 128b can be electrically connected to the first connector 112 disposed on the back surface 116 of the display 110.

Referring to FIGS. 2 and 3 at the same time, when the back cover 128 is opened relative to the docket station 126 at an angle A, the display 110 is adaptable to be assembled to the docket station 126 of the base 120 along an assembling direction D2. Here, the assembling direction D2 is substantially a display surface 114 parallel with the display 110. In other words, the display 110 is vertically inserted on the docket station 126 of the base 120. The angle A is in a range of 0 degree to 45 degrees, for example. Since the back cover 128 is opened at an angle A relative to the docket station 126, when the display 110 is assembled to the docket station 126, the second connector 122 on the back cover 128 is not blocked by the display 110.

Referring to FIGS. 4 and 5, when the back cover 128 is closed relative to the docket station 126, the second connector 122 of the back cover 128 is connected with the first connector 122 of the display 110, and the back cover 128 covers the back surface 116 of the display 110. At this time, the display 110 can be electrically connected with the body 124 of the base 120 via the first connector 112 and the second connector 122.

Since the display 110 of the embodiment is assembled to the base 120 first (i.e. to be positioned first), the second connector 122 of the base 120 is subsequently connected to the first connector 112 (i.e. to be connected later) of the display 110 along the connecting direction D1 that is perpendicular to the display surface 114 of the display 110. As compared with conventional tablet PC that is vertically inserted on the docking station, the electronic device 100 in the embodiment can have better assembling accuracy.

In summary, in the display of the electronic device of the invention, the first connector is disposed on the back surface opposite to the display surface. As compared with conventional tablet PC of which the connector is disposed on the side of the tablet PC, the size of the first connector of the invention is not restricted to the thickness of the display. In addition, the display of the electronic device in the invention is assembled to the base first. Subsequently, the second connector of the base is connected to the first connector of the display along the connecting direction that is perpendicular to the display surface of the display. As compared with conventional tablet PC that is vertically inserted on the docking station, the electronic device in the invention can have better assembling accuracy.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. An electronic device, comprising:
a display, comprising a first connector and a display surface and a back surface opposite to each other, wherein the first connector is disposed on the back surface; and
a base, comprising a second connector, wherein when the display is assembled to the base, the second connector of the base is connected with the first connector of the display along a connecting direction, and the connecting direction is perpendicular to the display surface of the display.

2. The electronic device according to claim 1, wherein the base comprises:
a body;
a docket station, disposed on the body; and
a back cover, pivoted to the docket station to be opened or closed relative to the docket station, wherein the back cover comprises the second connector.

3. The electronic device according to claim 2, wherein the back cover comprises a cover portion and a connecting portion, the connecting portion is connected between the cover portion and the docket station, and the second connector is disposed on the connecting portion.

4. The electronic device according to claim 2, wherein when the back cover is opened relative to the docket station at an angle, the display is assembled to the docket station of the base along an assembling direction.

5. The electronic device according to claim 4, wherein the angle is in a range of 0 degree to 45 degrees.

6. The electronic device according to claim 4, wherein the assembling direction is parallel with the display surface of the display.

7. The electronic device according to claim 2, wherein when the back cover is closed relative to the docket station, the second connector of the back cover is connected with the first connector of the display, and the back cover covers the back surface of the display.

8. The electronic device according to claim 1, wherein the display is a tablet PC.
